(19) United States
(12) Patent Application Publication
(10) Pub. No.: US 2007/0243420 A1
(43) Pub. Date: Oct. 18, 2007

(54) Magnetic Recording Medium

(75) Inventors: Takashi Chiba, Akita-shi (JP); Jun Ariake, Akita-shi (JP); Naoki Honda, Akita-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: JAPAN SCIENCE AND TECHNOLOGY AGENCY, Saitama (JP); AKITA PREFECTURE, a government agency of Japan, Akita (JP)

(21) Appl. No.: 11/576,348

(22) PCT Filed: Oct. 4, 2005
(86) PCT No.: PCT/JP05/18373

§ 371 Date: Mar. 30, 2007

(30) Foreign Application Priority Data
Oct. 5, 2004 (JP) 2004-292954

(51) Int. Cl. G11B 5/706

(52) U.S. Cl. 428/846

(57) ABSTRACT

A magnetic recording medium has a recording layer formed of a magnetic material represented by the following general formula:
[(Co₁₋ₘPtₘ)₁₋ₙCrₙ]_{100-x-y}TiₓO_{y}, where m and n are atomic ratios, m is 0.2 or more and 0.4 or less, n is 0 or more and 0.1 or less, x is 9 at. % or more and 13 at. % or less, and y/x is 1.8 or more and 2.3 or less.

### TECHNICAL FIELD

The present invention relates to a magnetic recording medium, and more specifically to a magnetic recording medium to be mounted on various recording devices such as computers and video recorders.

### BACKGROUND ART

Perpendicular magnetic recording is receiving attention as a technique of increasing magnetic recording density. As a recording medium to be used in the perpendicular magnetic recording, there has been proposed such a medium that uses a recording layer having a granular structure in which crystal grains of Co—Pt—Cr are surrounded by SiO₂ (see Jpn. Pat. Appln. KOKAI Publication No. 2003-178413). In this medium, if the crystal grains of ferromagnetic Co—Pt—Cr are completely isolated by SiO₂ to each other, it is expected that the magnetic interaction between the magnetic grains are lowered and low noise characteristics can be provided. Further, it is expected that the high crystalline magnetic anisotropy of Co—Pt—Cr crystal, whose c-axis is orientated in the direction perpendicular to the film plane, with lowered magnetic interaction between the magnetic grains, leads to a high perpendicular coercivity.

As a method of manufacturing such a recording layer as described above, it has been reported sputtering which uses a target of a mixture material of a Co—Pt—Cr alloy and SiO₂. When deposition is performed using a target made of a mixture material of a metal and an oxide, a film having a granular structure in which metal grains are surrounded by the oxide can be provided.

However, since the M-H loop of the resultant film in the perpendicular direction has an inclination parameter α of about 2, where α is defined as 4π(dM/dH), it is believed that large magnetic coupling remains between the grains. Moreover, it is undeniable that there is a possibility that a constituent element of the oxide may be slightly mixed in the metal grains. It is assumed that, if Si is mixed in magnetic grains of the film deposited using a target made of a mixture material of Co—Pt—Cr alloy and SiO₂ as described above, the perpendicular coercivity of the film is significantly deteriorated. On the premise that it is unavoidable for the element of the oxide to be slightly mixed in the magnetic grains, it is required to suppress as much as possible deterioration of the perpendicular coercivity for the deposited film.

### DISCLOSURE OF INVENTION

An object of the present invention is to provide a magnetic recording medium that can achieve a high perpendicular coercivity by reducing magnetic coupling between magnetic grains.

According to an aspect of the present invention, there is provided a magnetic recording medium characterized by comprising a recording layer formed of a magnetic material represented by the following general formula:
[(Co₁₋ₘPtₘ)₁₋ₙCrₙ]_{100-x-y}TiₓO_{y},
where m and n are atomic ratios, m is 0.2 or more and 0.4 or less, n is 0 or more and 0.1 or less, x is 9 at. % or more and 13 at. % or less, and y/x is 1.8 or more and 2.3 or less.

The magnetic recording medium of the present invention is in a form that the CoPt-based alloy and TiO₂ are phase-separated.

In the present invention, it is preferable that the recording layer should have a perpendicular magnetic anisotropy. Further, in the magnetic recording medium of the present invention, it is preferable that the recording layer should be deposited under pressure of Ar gas atmosphere between 4 Pa or more and 9 Pa or less.

### BRIEF DESCRIPTION OF DRAWINGS

FIG. 1 is a cross-sectional view showing an example of a magnetic recording medium according to the present invention;

FIG. 2 is a graph showing change in the perpendicular coercivity of the film with respect to the Pt content of the CoPt alloy film;

FIG. 3 is cross-sectional view showing a magnetic recording medium manufactured in the Examples;

FIG. 4 is a graph showing the Ti and 0 elemental contents of the film with respect to the Ar gas pressure during deposition of the recording layer for the magnetic recording medium in Example 1;

FIG. 5 is a graph showing change in perpendicular coercivity Hc with respect to the Ti content of the film for the magnetic recording medium in Example 1;

FIG. 6 is a graph showing change in the atomic ratio of O/Ti in the deposited recording layer for the magnetic recording medium in Example 1;

FIG. 7 is a graph showing relationship between the ratio of Cr/(Co+Pt+Cr) and the perpendicular coersivity for the magnetic recording medium in Example 1;

FIG. 8 is a graph showing the evaluation results of Example 1, Comparative Example 1 and Comparative Examples together; and

FIG. 9 is a graph showing relationship between the linear recording density and SN ratio for each of a medium having a Co₈₀Pt₂₀—TiO₂ recording film according to the present invention and a conventional medium having a CoPtCr—SiO₂ recording film.

### BEST MODE FOR CARRYING OUT THE INVENTION

Preferred embodiments of the present invention will now be described with reference to drawings.

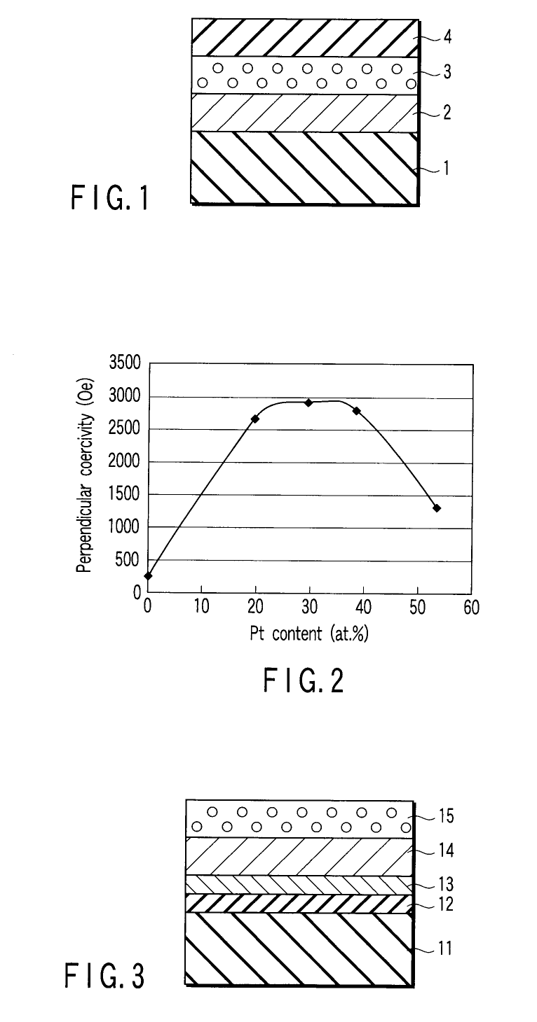

FIG. 1 is a cross-sectional view showing an example of a magnetic recording medium according to the present invention. The medium has a structure that, on a substrate 1, an underlayer 2, a recording layer 3 containing crystal grains of a Co—Pt-based alloy and TiO₂ that surrounds the grains, and a protection layer 4 are formed in this order.

Any material may be used for the substrate 1 as long as it has such a mechanical strength that it does not easily broken and has a smooth surface. Examples of such a material include glass, metal and plastics. The underlayer 2 may be omitted or it may have a multi-layered structure. Examples of the underlayer include a soft magnetic material such as Ni—Fe for assisting recording and a non-magnetic film of, for example, Pt or Ru for securing crystal orientation of the recording layer. The thickness of the underlayer 2 is not particularly limited.

The protection layer 4 may be omitted or it may have a multi-layered structure. Examples of the protection layer 4 include hard films such as carbon and TiN. Further, a liquid or solid lubricant may be applied to the surface of the protection film 4. The protection layer 4 should preferably be as thin as possible since the recording characteristics can be improved as the distance between the tip of the magnetic head and the surface of the recording layer becomes shorter.

The recording layer 3 is a film having a granular structure containing crystal grains of a Co—Pt-based alloy and TiO₂ grain boundaries surround the grains. Although it is difficult to know the states of the crystal grains and grain boundaries, or the details of the elemental composition separately, it is necessary that the layer should entirely satisfy the following requirements with respect to the elemental composition: (1) The Ti content (x) should be 9 at. % or more and 13 at. % or less; (2) The ratio of 0 to Ti (y/x) should be 1.8 or more and 2.3 or less in atomic ratio; (3) Of all the elements except for Ti and 0, the ratio of sum of Co and Pt (1-n) should be 0.9 or more in atomic ratio and the ratio of Cr (n) should be 0.1 or less; and (4) The ratio of Pt (m) to the sum of Co and Pt should be 0.2 or more and 0.4 or less in atomic ratio.

If the Ti content (x) is less than 9 at. %, the absolute amount of the oxide is insufficient to form non-magnetic grain boundaries between the crystal grains. If the Ti content (x) exceeds 13 at. %, it becomes difficult to maintain the crystal orientation of the grains.

When all of O and Ti in the film form the Ti oxide, and these elements do not exist in any other forms, the ratio of O to Ti (y/x) is made 2.0 in atomic ratio. If the ratio of O to Ti in the film is less than 1.8, a significant part of Ti atoms in a metallic state enters the CoPt alloy magnetic grains, thereby deteriorating the magnetic properties of the recording layer. On the other hand, if the ratio of 0 to Ti in the film is more than 2.3, a significant part of O atoms enters the CoPt alloy magnetic grains to oxidize Co, thereby deteriorating the magnetic properties of the recording layer.

If the ratio of sum of Co and Pt (1-n) to all the elements except for Ti and O, that is, the elements assumed to form the crystal grains, is less than 0.9 in atomic ratio, the perpendicular magnetic anisotropy is deteriorated. However, for the purpose of noise reduction, it is possible to add an element other than Co and Pt, for example, Cr at a ratio (n) of 0.1 or less in atomic ratio to all the elements except for Ti and O in the recording layer.

Further, in the CoPt-based alloy, a high coercivity can be provided when the ratio of Pt (m) to the sum of Co and Pt is in a range of 0.2 or more and 0.4 or less in atomic ratio. However, in either case where the ratio of Pt (m) is lower or higher than the above range, the coercivity is deteriorated. Thus, it is necessary that the ratio of Pt (m) to the sum of Co and Pt in the film should be 0.2 or more and 0.4 or less in atomic ratio.

[Preliminary Study]

To know an appropriate ratio of Co to Pt for an CoPt alloy, CoPt alloy films having a thickness of about 30 nm with various Pt ratios ranging from 0 at. % to 53.5 at. % were prepared, and they were examined in terms of perpendicular coercivity. The results were given in FIG. 2. When the Pt ratio fell in a range of 0.2 or more and 0.4 or less, a high coercivity of 2.5 kOe or higher was provided. However, in either case where the ratio of Pt (m) was lower or higher than the above range, the perpendicular coercivity was deteriorated.

### EXAMPLES

The present invention will now be described in more details with reference to Examples.

### Example 1

In this Example, a magnetic recording medium shown in FIG. 3 was manufactured. As the substrate 11, a 2.5-inch glass disk was used. A carbon film 12 having a thickness of about 2 nm was deposited under an Ar gas pressure of 1 Pa, a Pt film 13 having a thickness of about 5 nm was deposited under an Ar gas pressure of 0.07 Pa and a Ru film 14 having a thickness of about 15 nm was deposited under an Ar gas pressure of 3 Pa, thereby forming underlayers. Subsequently, a TiO₂ chip was placed on the surface of a Co₈₀Pt₂₀ (at. %) target, and a recording layer 15 having a thickness of about 15 nm was deposited under Ar gas pressures in a range of from 1 to 10 Pa by DC magnetron sputtering. In the deposition of any of the layers, the substrate was not heated.

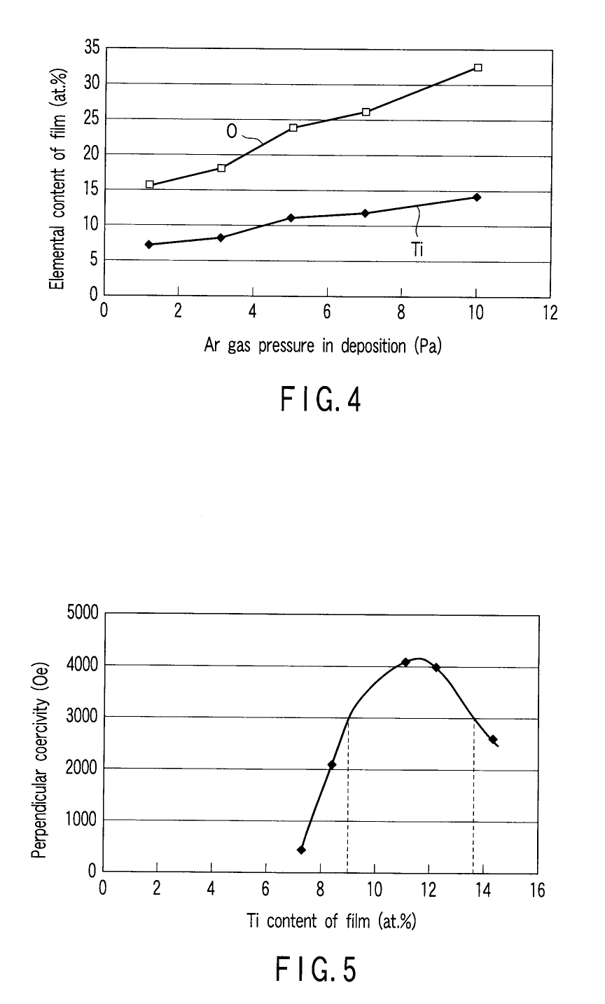

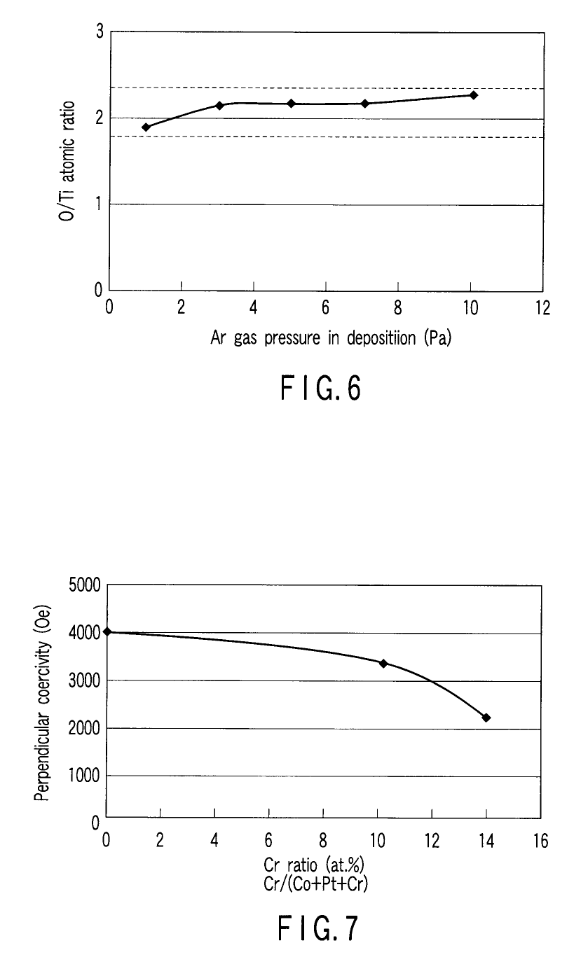

The elemental composition in the recording layer of the medium was analyzed by X-ray photoelectron spectroscopy after sputter etching the surface by 5 nm. The perpendicular coercivity was measured with a vibrating sample magnetometer. FIG. 4 shows the Ti and elemental contents of the film with respect to the Ar gas pressure during deposition of the recording layer. As can be seen, the elemental content of the film changed as the Ar gas pressure was varied during deposition of the recording layer, and the oxide amount increased as the gas pressure was raised. FIG. 5 shows the change in the value of perpendicular coercivity Hc with respect to the Ti content of the film. A high perpendicular coercivity of 3 kOe or higher was provided in a range of the Ti content of 9 to 13 at. %. FIG. 6 shows the atomic ratio of 0 to Ti in the film with respect to the Ar gas pressure during deposition of the recording layer. In this Example, the atomic ratio of 0 to Ti was within a range of 1.8 to 2.3. Further, the sample which exhibited the maximum Hc value had as low as 1.4 of inclination parameter α of the M-H loop in the direction perpendicular to the film.

### Example 2

In the similar procedures to those in Example 1, underlayers of carbon, Pt and Ru were deposited on a glass disk substrate. Then, TiO₂ and Cr chips were placed on the surface of a Co₈₀Pt₂₀ (at. %) target, and a recording layer having a thickness of about 15 nm was deposited under an Ar gas pressure of 5 Pa by RF magnetron sputtering. The elemental composition of this film was Co: 48.2 at. %, Pt: 13.1 at. %, Cr: 6.0 at. %, Ti: 9.8 at. % and 0:22.9 at. %, and the ratio of Cr to the elements except for Ti and 0 was 8.9 at. %. Further, the film had Hc of 3,312 Oe.

Also, another recording layer was deposited in the same manner as above except that the number of Cr chips placed on the surface of the target was increased. The ratio of Cr in this film was 12 at. %. The film had Hc of 2,100 Oe.

FIG. 7 shows the relationship between the ratio of Cr/(Co+Pt+Cr) and the perpendicular coercivity. When Cr was added as a metal element besides Co and Pt to the recording layer, the Hc was decreased. However, if the ratio of Cr was 10 at. % or less, the Hc value was maintained to be 3 kOe or higher. Thus, it can be understood that even if a small amount of element other than Co and Pt was added as the constituent element for the crystal grains, excellent magnetic properties can be maintained.

### Comparative Example 1

In the similar procedures to those in Example 1, underlayers of carbon, Pt and Ru were deposited on a glass disk substrate. Then, using a target having 70% in volume ratio of Co₈₀Pt₂₀ (at. %), and 30% in volume ratio of SiO₂, a recording layer having a thickness of about 15 nm was deposited under Ar gas pressure in a range of 3 to 10 Pa. The perpendicular coercivity varied as the Ar gas pressure in deposition of the film changed, and the maximum value (a value close to that disclosed in Reference Document 1) was obtained at 7 Pa. The sample which exhibited the maximum Hc value had 2.0 of an inclination parameter α of the M-H loop, which was larger than that in Example 1.

### Comparative Example 2

In the similar procedures to those in Example 1, underlayers of carbon, Pt and Ru were deposited on a glass disk substrate. Then, a Cr₂O₃ chip was placed on the surface of a Co₈₀Pt₂₀ (at. %) target, and a recording layer having a thickness of about 15 nm was deposited under Ar gas pressure in a range of 3 to 10 Pa by DC magnetron sputtering. The perpendicular coercivity varied as the Ar gas pressure in deposition of the film changed, and the maximum Hc value was obtained at 5 Pa. The sample which exhibited the maximum Hc value had 1.9 of an inclination parameter α of the M-H loop, which was larger than that in Example 1.

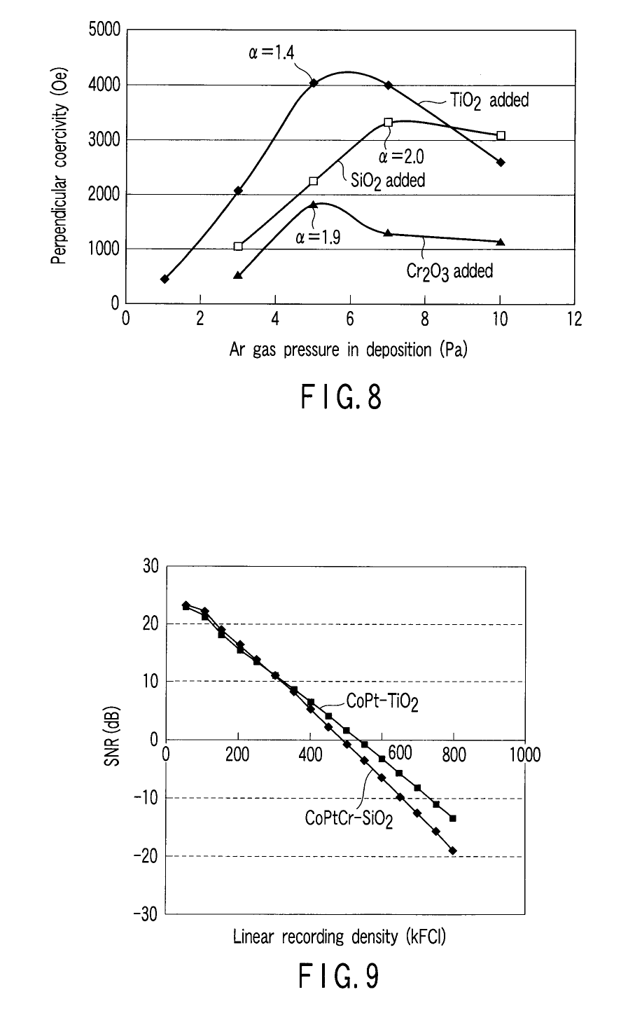

FIG. 8 summarizes the evaluation results of Example 1, Comparative Example 1 and Comparative Example 2 together.

As described above, the medium that used TiO₂ as an oxide constituting the recording layer exhibited a high perpendicular coercivity and a low inclination parameter α of the M-H loop as compared to the media that used SiO₂ or Cr₂O₃ as an oxide constituting the recording layer, if the Ti and O contents of the film were adjusted appropriately depending on deposition conditions. The results suggest that a medium that uses TiO₂ oxide involves smaller magnetic interaction between magnetic grains as compared to that of a medium that uses SiO₂ or Cr₂O₃. Also, a medium that contained 6.0 at. % of Cr in the recording layer (8.9 at. % in the elements except for Ti and 0) exhibited a high perpendicular coercivity of 3 kOe or higher.

Further, a medium of the present invention having a Co₈₀Pt₂₀—TiO₂ recording layer and a conventional medium having a CoPtCr—SiO₂ recording layer were compared in terms of read/write characteristics. Data recording was carried out with various linear recording densities and the data were read to determine the SN ratio (dB). A longitudinal recording head was used for read/write tests, which had a write head width Tww of 0.19 μm, a read head width Twr of 0.12 μm, and a gap length Gs=0.10 μm.

FIG. 9 shows relationship between the linear recording density and SN ratio. As can be seen, the medium of the present invention exhibited a higher SN ratio than that of the conventional medium. For example, at a liner recording density of 600 kFCI, the medium of the present invention exhibited an SN ratio about 3 dB higher than that of the conventional medium. This difference in the SN ratio implies that the medium of the present invention can be used at a recording density as high as twice that of the conventional medium.

1. A magnetic recording medium, characterized by comprising: a recording layer formed of a ferromagnetic material represented by the following general formula:
[(Co₁₋ₘPtₘ)₁₋ₙCrₙ]_{100-x-y}TiₓO_{y},
where m and n are atomic ratios, m is 0.2 or more and 0.4 or less, n is 0 or more and 0.1 or less, x is 9 at. % or more and 13 at. % or less, and y/x is 1.8 or more and 2.3 or less.

2. The magnetic recording medium according to claim 1, characterized in that the recording layer has perpendicular magnetic anisotropy.

3. The magnetic recording medium according to claim 1, characterized in that the recording layer is deposited under a pressure of Ar gas atmosphere between 4 Pa or more and 9 Pa or less.
